(19) United States
(12) Patent Application Publication
(10) Pub. No.: US 2002/0074756 A1
(43) Pub. Date: Jun. 20, 2002

(54) Brake device for scooter

(75) Inventor: Yu-Jou Tsai, Kaohsiung (TW)

Correspondence Address: Bacon & Thomas, 4th Floor, 625 Slaters Lane, Alexandria, VA, 22314, US

(73) Assignee: Sun Yu Le Co., Ltd., Kaohsiung (TW)

(21) Appl. No.: 09/736,212

(22) Filed: Dec. 15, 2000

(51) Int. Cl. B62M 1/00

(52) U.S. Cl. 280/87.041

(57) ABSTRACT

A brake device of a scooter of the present invention includes a scooter body having a front steering axle provided with a front wheel and a seat hole, and an axle pivotally provided with a rear wheel, and a brake pedal pivotally mounted on the scooter body by a pivot member and provided with a brake pad. When the brake pedal is trodden, the brake pad is rested on the rear wheel. A brake connecting member has a first end rested on the bottom of the brake pedal. The brake connecting member is pivoted by a ring to rotate. The brake connecting member has a second end connected to a first end of a pulling member. A front brake member is pulled by a second end of the pulling member. The front brake member is pivotally mounted on the seat hole of the scooter body, and is provided with a brake pad. When the brake pedal is trodden, the brake pedal and the front brake member are respectively urged on the rear wheel and the front wheel synchronously by a drawing action of the pulling member.

### BACKGROUND OF THE INVENTION

1. Field of the Invention

The present invention relates to a brake device of a scooter that can be used to perform a brake action so that the front wheel and the rear wheel of the scooter can be braked synchronously, thereby enhancing the braking effect of the scooter.

2. Description of the Related Prior Art

A conventional rear wheel brake device of a scooter in accordance with the prior art is shown in FIG. 7, wherein, the rear wheel 60 of the scooter is provided with a brake device for reducing the speed of the scooter or stopping movement of the scooter. The brake device uses an elastic member 62 to urge a wheel cover 61 by a support 622 to deviate from the rear wheel 60 so that the scooter can travels fluently. When a pressure is exerted on the wheel cover 61, the brake arcuate face 611 of the wheel cover 61 is in contact with the rear wheel 60, thereby reducing the speed or stopping movement of the scooter by friction of contact.

The conventional brake device is used to perform a brake action on the rear wheel 60. Therefore, when the scooter is moved at a high speed, the traveling inertia force is exerted on the front wheel if only the rear wheel 60 is braked so that the rear wheel 60 is easily lifted. Therefore, the rear wheel 60 easily slips, thereby greatly affecting the stability of the scooter.

### SUMMARY OF THE INVENTION

The primary objective of the present invention is to provide a brake device of a scooter, which can be used to brake the front wheel and the rear wheel of the scooter synchronously so that the speed reduction and the stop of the scooter can be performed more stably.

A brake device of a scooter of the present invention includes a scooter body having a front steering axle provided with a front wheel and a seat hole, and an axle pivotally provided with a rear wheel, and a brake pedal pivotally mounted on the scooter body by a pivot member and provided with a brake pad. When the brake pedal is trodden, the brake pad is rested on the rear wheel. A brake connecting member has a first end rested on the bottom of the brake pedal. The brake connecting member is pivoted by a ring to rotate. The brake connecting member has a second end connected to a first end of a pulling member. A front brake member is pulled by a second end of the pulling member. The front brake member is pivotally mounted on the seat hole of the scooter body, and is provided with a brake pad. When the brake pedal is trodden, the brake pedal and the front brake member are respectively urged on the rear wheel and the front wheel synchronously by a drawing action of the pulling member.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a brake device for a scooter in accordance with a first embodiment of the present invention;

FIG. 2 is a side plan cross-sectional assembly view of the brake device for a scooter as shown in FIG. 1;

FIG. 3 is an operational view of the brake device for a scooter as shown in FIG. 2 in use;

FIG. 4 is a preferred embodiment of the brake device for a scooter as shown in FIG. 2, wherein a guiding roller is added;

FIG. 5 is a side plan cross-sectional assembly view of a brake device for a scooter in accordance with a second embodiment of the present invention;

FIG. 6 is a partially cut-away perspective view of a brake device for a scooter in accordance with a third embodiment of the present invention, wherein the scooter is provided with two rear wheels; and

FIG. 7 is a side plan view of a conventional rear wheel brake device of a scooter in accordance with the prior art.

### DETAILED DESCRIPTION OF THE PREFERRED EMBODIMENTS

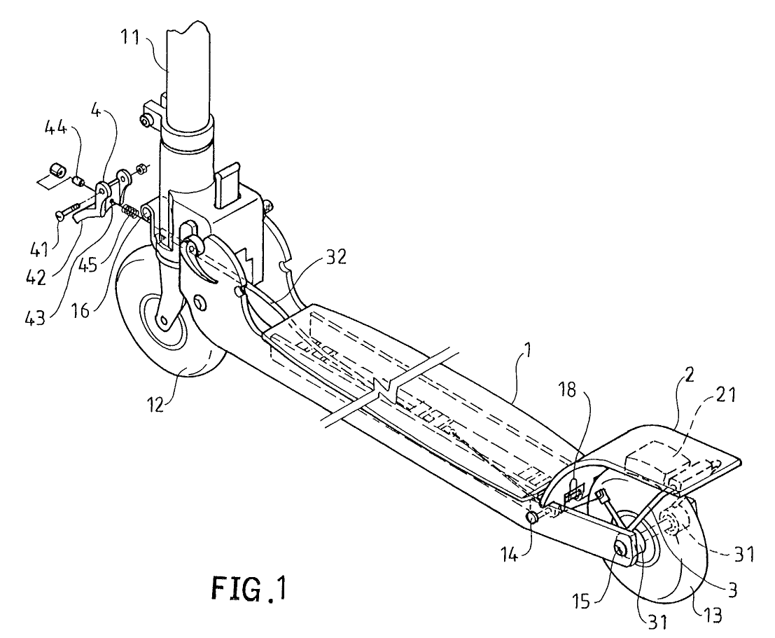

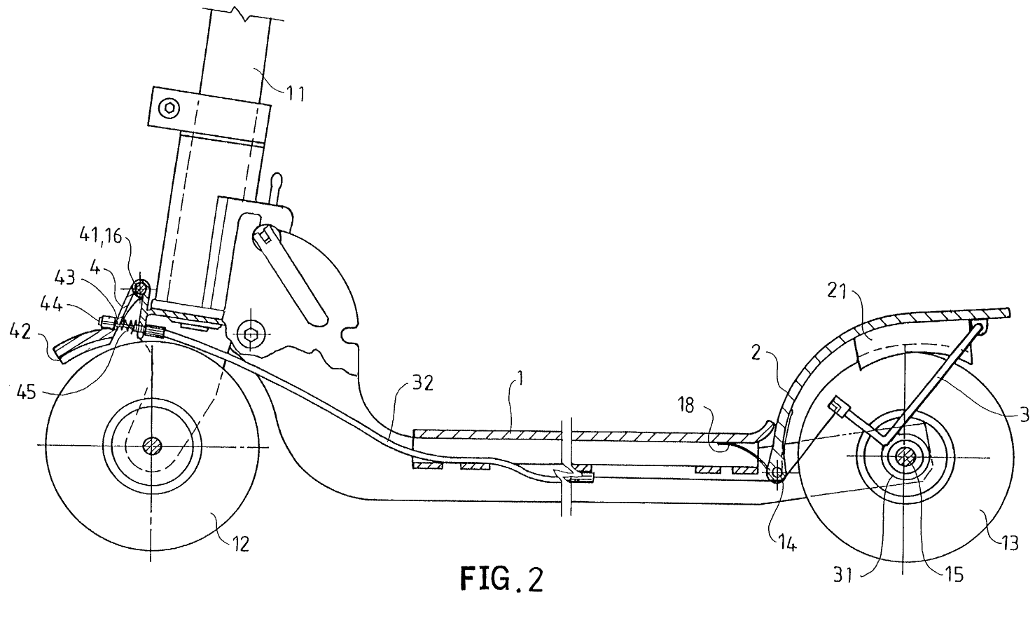

Referring to the drawings and initially to FIGS. 1 and 2, a brake device of a scooter in accordance with a first embodiment of the present invention primarily comprises a scooter body 1, a brake pedal 2, a brake connecting member 3, and a front brake member 4.

The scooter body 1 is a conventional scooter frame, and includes a front steering axle 11, a front wheel 12, and a rear wheel 13. The rear end of the scooter body 1 is pivotally provided with the brake pedal 2 by a pivot member 14 such as a shaft or the like.

The brake pedal 2 is pivotally mounted on the scooter body 1 by the pivot member 14, so that the brake pedal 2 is pivoted about the pivot member 14. The brake pedal 2 itself forms a brake board for the rear wheel 13, or is additionally provided with a brake pad 21 as shown in FIGS. 1 and 2 so that the brake pad 21 can be rested on or detached from the rear wheel 13. The brake pedal 2 itself is rested by one end of the brake connecting member 3. The brake pedal 2 is normally retained to space from the rear wheel 13 by the restoring force of an elastic member 18.

The brake connecting member 3 has one end rested on the bottom of the brake pedal 2. In the preferred embodiment, it is more appropriate that the brake connecting member 3 is pivotally connected with the brake pedal 2. The brake connecting member 3 itself is fixed to a ring 31 which is fitted on an axle 15 which is pivoted to the rear wheel 13 so that the brake connecting member 3 is able to rotate about the axle 15. The other end of the brake connecting member 3 is connected to a pulling member 32 which may be a conventional wire, cable or the like. The other end of the pulling member 32 is used to pull the front brake member 4 to perform the brake action.

The front brake member 4 is pivotally mounted on the seat hole 16 of the steering axle 11 by a pivot member 41 such as a shaft or the like, and is pulled by one end of the pulling member 32 so that the front brake member 4 is able pivot about the pivot member 41. The front brake member 4 itself forms a brake board for the front wheel 12, or is additionally provided with a brake pad 41 as shown in FIGS. 1 and 2 so that the brake pad 41 can be rested on the front wheel 12. Connection between the pulling member 32 and the front brake member 4 may be arranged as shown in FIG. 2 so that one end of the pulling member 32 passes through a hole 43 defined in the front brake member 4, and is clamped with a cap head 44 which has a diameter greater than that of the hole 43 of the front brake member 4, and an elastic member 45 is mounted on the pulling member 32 and is pressed between the front brake member 4 and a wall of the seat hole 16. Therefore, when the pulling member 32 is released after drawing the front brake member 4, the front brake member 4 is pressed by the elastic member 45 to return to its original position, and the pulling member 32 can be used to draw the brake connecting member 3 to return to its original position so that the brake pad 21 of the brake pedal 2 and the brake pad 42 of the front brake member 4 can be detached from the rear wheel 13 and the front wheel 12 respectively as shown in FIG. 2.

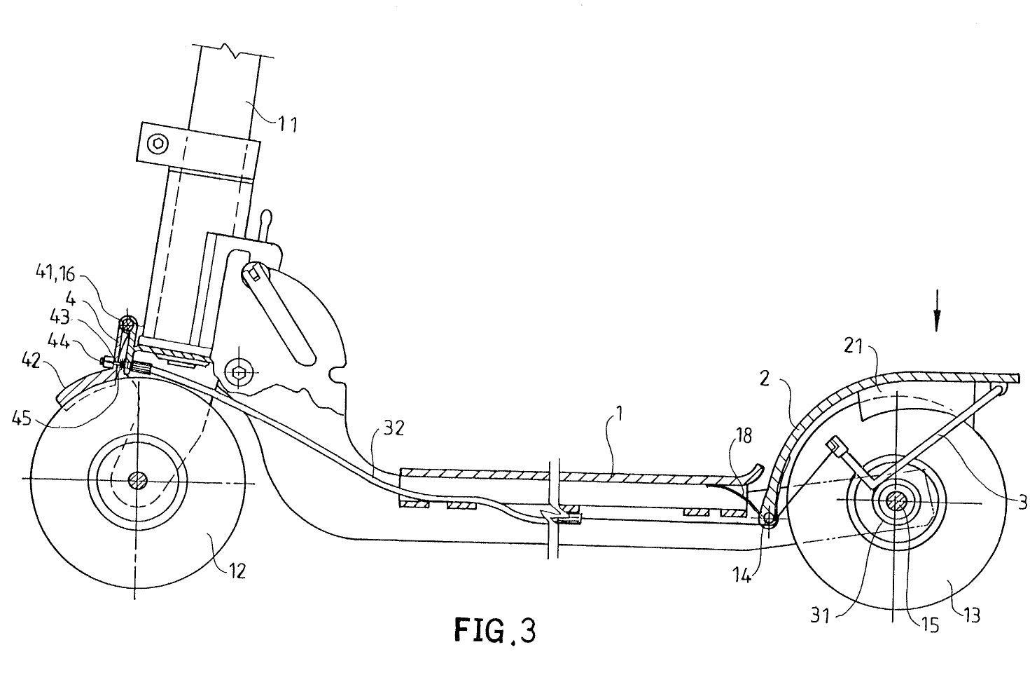

As shown in FIG. 3, when the rider wishes to reduce the speed or stop the scooter, the brake pedal 2 is trodden so that the brake pad 21 of the brake pedal 2 is urged on the rear wheel 13. At the same time, the brake pedal 2 draws the front brake member 4 to perform the brake action by means of the pulling member 32 so that the brake pad 42 of the front brake member 4 can be urged on the front wheel 12 synchronously. Therefore, the front wheel 12 and the rear wheel 13 of the scooter can reduce their speeds or stop synchronously.

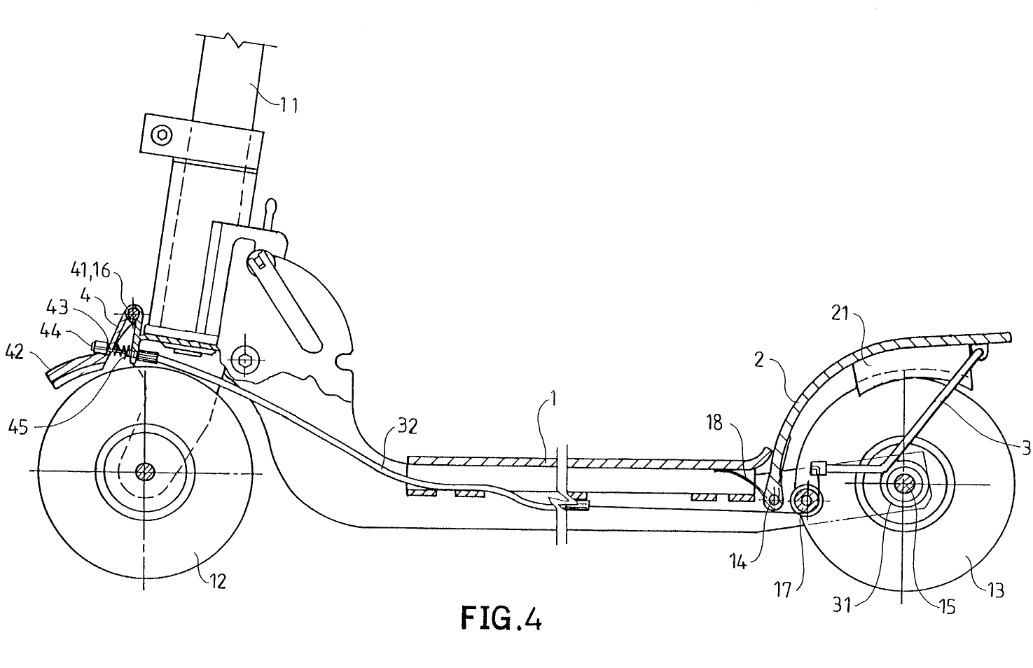

As shown in FIG. 4, the pulling member 32 is reeved through a guiding roller 17 so that the action of the pulling member 32 is more fluent and smooth.

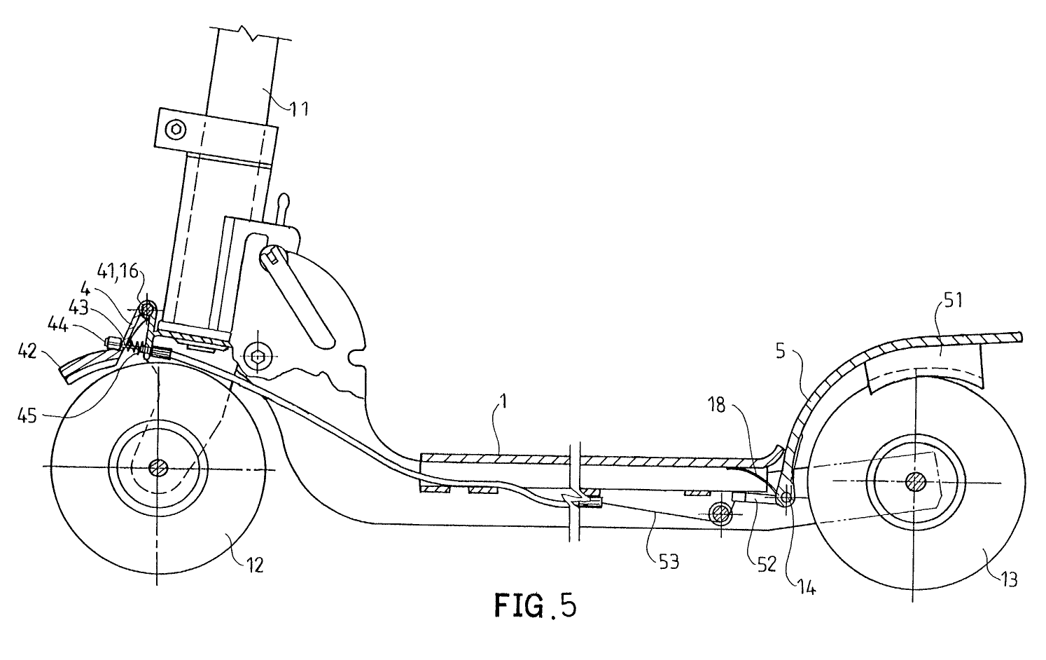

Referring to FIG. 5, a brake device of a scooter in accordance with a second embodiment of the present invention primarily comprises a scooter body 1, a brake pedal 5, and a front brake member 4.

The scooter body 1 is a conventional scooter frame, and includes a front steering axle 11, a front wheel 12, and a rear wheel 13. The rear end of the scooter body 1 is pivotally provided with the brake pedal 5 by a pivot member 14 such as a shaft or the like.

The brake pedal 5 is pivotally mounted on the scooter body 1 by the pivot member 14, so that the brake pedal 5 is pivoted about the pivot member 14. The brake pedal 5 itself forms a brake board for the rear wheel 13, or is additionally provided with a brake pad 51 as shown in FIG. 5 so that the brake pad 51 can be rested on or detached from the rear wheel 13. A rod 52 extends from the brake pedal 5 which is combined with one end of a pulling member 53 which may be a conventional wire, cable or the like. The other end of the pulling member 53 is connected to the front brake member 4. The rod 52 and the brake pedal 5 are respectively located at the two sides of the pivot member 14. Therefore, when the brake pedal 5 is trodden, the pulling member 53 is used to draw the front brake member 4 to perform the brake action whereby the brake pad 42 of the front brake member 4 can be urged on the front wheel 12 so that the front wheel 12 and the rear wheel 13 of the scooter can reduce their speeds or stop synchronously.

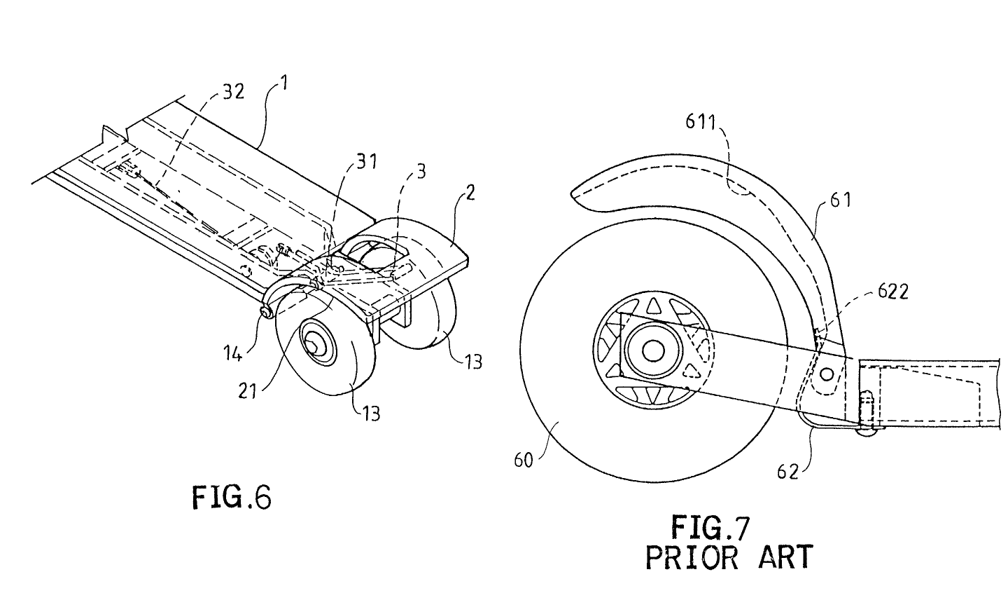

Referring to FIG. 6, in accordance with a third embodiment of the present invention, the scooter is provided with two rear wheels 13. The pivot member 14 pivoted with the brake pedal 2 is pivoted to the brake connecting member 3 at the same time. The brake connecting member 3 has one end rested on the bottom of the brake pedal 2, and is pivoted on the pivot member 14 by a ring 31. The other end of the brake connecting member 3 is connected to one end of a pulling member 32 whose other end is connected to the front brake member 4 as shown in FIGS. 1 and 2. Therefore, the brake pedal 2 is trodden so that the brake pad 21 of the brake pedal 2 is urged on the rear wheel 13, and the brake pad 42 of the front brake member 4 is urged on the front wheel 12 synchronously. Therefore, the front wheel 12 and the rear wheel 13 of the scooter can reduce their speeds or stop synchronously.

Accordingly, the construction of the present invention can be used to perform a brake action so that the front wheel and the rear wheel of the scooter can reduce their speeds or stop synchronously. Therefore, when the scooter performs a brake action for reducing its speed or stopping its movement, the brake action can be performed stably and smoothly without incurring slip, and the brake distance can be shortened.

Although the invention has been explained in relation to its preferred embodiment as mentioned above, it is to be understood that many other possible modifications and variations can be made without departing from the scope of the present invention. It is, therefore, contemplated that the appended claim(s) will cover such modifications and variations that fall within the true scope of the invention.

What is claimed is:

1. A brake device of a scooter comprising:
a scooter body, having a front steering axle provided with a front wheel and a seat hole, and an axle pivotally provided with a rear wheel;
a brake pedal, pivotally mounted on the scooter body by a first pivot member, to abut the rear wheel when the brake pedal is trodden;
a brake connecting member, pivotally mounted on the axle of the rear wheel by a ring to rotate about the axle, the brake connecting member having a first end located at a first side of the ring and rested on a bottom of the brake pedal, and a second end located at a second side of the ring and connected to a first end of a pulling member; and
a front brake member, pivotally mounted on the seat hole of the scooter body by a second pivot member, the front brake member being pulled by a second end of the pulling member;
wherein, when the brake pedal is trodden, the brake pedal and the front brake member are respectively urged on the rear wheel and the front wheel synchronously by a drawing action of the pulling member.

2. The brake device for a scooter as claimed in claim 1, wherein the pulling member is reeved through a guiding roller.

3. The brake device for a scooter as claimed in claim 1, wherein the pulling member passes through a hole defined in the front brake member, and is combined with a cap head which has a diameter greater than that of the hole of the front brake member, and an elastic member is mounted on the pulling member and is pressed between the front brake member and a wall of the seat hole.

4. The brake device for a scooter as claimed in claim 1, wherein the brake pedal is provided with a brake pad.

5. The brake device for a scooter as claimed in claim 1, wherein the front brake member is provided with a brake pad.

6. A brake device of a scooter comprising:
a scooter body, having a front steering axle provided with a front wheel and a seat hole, and an axle pivotally provided with a rear wheel;
a brake pedal, pivotally mounted on the scooter body by a first pivot member, to abut the rear wheel when the brake pedal located on one side of the first pivot member is trodden;
a rod, mounted on the brake pedal and located on the other side of the first pivot member, the rod combined with a first end of a pulling member; and
a front brake member, pivotally mounted on the seat hole of the scooter body by a second pivot member, the front brake member being pulled by a second end of the pulling member;
wherein, when the brake pedal is trodden, the brake pedal and the front brake member are respectively urged on the rear wheel and the front wheel synchronously by a drawing action of the pulling member.

7. The brake device for a scooter as claimed in claim 6, wherein the pulling member is reeved through a guiding roller.

8. The brake device for a scooter as claimed in claim 6, wherein the pulling member passes through a hole defined in the front brake member, and is combined with a cap head which has a diameter greater than that of the hole of the front brake member, and an elastic member is mounted on the pulling member and is pressed between the front brake member and a wall of the seat hole.

9. The brake device for a scooter as claimed in claim 6, wherein the brake pedal is provided with a brake pad.

10. The brake device for a scooter as claimed in claim 6, wherein the front brake member is provided with a brake pad.
